(19) United States
(12) Patent Application Publication
(10) Pub. No.: US 2025/0158322 A1
(43) Pub. Date: May 15, 2025

(54) ROTATABLE TERMINAL MODULE

(71) Applicant: Chicony Power Technology Co., Ltd., New Taipei City (TW)

(72) Inventor: Kuo-Hsin Fang, New Taipei City (TW)

(21) Appl. No.: 18/392,155

(22) Filed: Dec. 21, 2023

(30) Foreign Application Priority Data
Nov. 9, 2023 (TW) 112143318

(51) Int. Cl. H01R 13/60; H01R 24/68

(52) U.S. Cl. CPC H01R 13/60; H01R 24/68

(57) ABSTRACT

A rotatable terminal module includes a base, a brake assembly, and a terminal assembly. The brake assembly is assembled on the base and includes a main body portion and a wing portion. The main body portion has a receiving groove and a locking portion, and the locking portion is locked to the base. The wing portion is located on a side of the main body portion, and the wing portion extends toward an end away from the receiving groove. The terminal assembly is assembled on the base and includes a rotating shaft and a conductive post. The rotating shaft is pivoted to the base. As the rotating shaft rotates, a protruding block on the rotating shaft enters the receiving groove along the wing portion or leaves the receiving groove. The conductive post is connected to the rotating shaft and drives the rotating shaft to rotate.

### CROSS-REFERENCE TO RELATED APPLICATION

This non-provisional application claims priority under 35 U.S.C. § 119 (a) to patent application No. 112143318 filed in Taiwan, R.O.C. on Nov. 9, 2023, the entire contents of which are hereby incorporated by reference.

### BACKGROUND

### Technical Field

A terminal module, and in particular, a rotatable terminal module.

### Related Art

To facilitate opening and closing by a user, it is designed that a conventional foldable terminal module can be operated with only a small force. However, during use of this structure that facilitates opening and closing, because a use direction of the user cannot be defined, for example, when the structure is inserted in a wall, a conductive terminal may be not in a normal angle due to a product weight (for example, 90 degrees), or the conductive terminal is folded by accident due to a touch with an external force. In this case, the conductive terminal may have poor contact and cause danger. Further, to keep the terminal module in an open state from being folded under an external force, a rib structure is disposed at a rotating shaft to generate an interfering force on a frictional structure of the terminal module, and the user needs to apply a large force to retract the conductive terminal. However, with this structure, a force required to open the terminal module is the same as a force required to retract the terminal module. To make it convenient for the user to open the conductive terminal, a small interfering force is designed, but the interfering force generated by the frictional structure cannot effectively achieve a safety protection function required when the conductive terminal is closed. For example, the foregoing conductive terminal is not in a normal angle or is folded due to a touch.

In addition, in the conventional foldable terminal module, it is usually designed that the frictional structure used for generating the interfering force is located on a terminal in contact with a conductive sheet. After long-time use by the user, constant friction between the frictional structure and the rib structure causes wear or deformation in the structure, resulting in the problem of poor contact in the terminal.

### SUMMARY

In view of this, according to an embodiment, a rotatable terminal module is provided, including a base, a brake assembly, and a terminal assembly. The base includes a conductive sheet. The brake assembly is assembled on the base and includes a main body portion and a wing portion. The main body portion has a receiving groove and a locking portion, and the locking portion is locked to the base. The wing portion is located on a side of the main body portion. The wing portion has a sliding stop portion on a side facing the base, and the sliding stop portion extends toward an end away from the receiving groove. The terminal assembly is assembled on the base and includes a rotating shaft and a conductive post. The rotating shaft has a protruding block. The rotating shaft is pivoted to the base. The protruding block corresponds to the receiving groove and the sliding stop portion. As the rotating shaft rotates, the protruding block enters the receiving groove along the sliding stop portion or leaves the receiving groove and stays at the sliding stop portion. The conductive post is connected to the rotating shaft and drives the rotating shaft to rotate. When the protruding block is accommodated in the receiving groove, the conductive post abuts the conductive sheet. When the protruding block leaves the receiving groove, the conductive post separates from the conductive sheet.

In some embodiments, the wing portion is connected to the main body portion, and the sliding stop portion extends from a groove edge of the receiving groove in a direction away from the receiving groove.

In some embodiments, the rotatable terminal module further includes a top cover, assembled on the base, where the brake assembly is connected to the top cover.

In some embodiments, the wing portion is connected to the top cover, the sliding stop portion is formed on a side of the wing portion facing the receiving groove, and a gap exists between the wing portion and the main body portion.

In some embodiments, the main body portion further includes a restraining block, and the restraining block extends from above corresponding to the receiving groove and is connected to the top cover.

In some embodiments, the top cover includes a restraining arm, and the restraining arm is connected to the top cover and extends toward the main body portion, and abuts above corresponding to the main body portion.

In some embodiments, the restraining arm abuts above corresponding to the receiving groove of the main body portion.

In some embodiments, the main body portion further includes a restraining block, and the restraining block is connected above corresponding to the receiving groove.

In some embodiments, an end of the conductive post close to the rotating shaft further includes an abutting portion, the protruding block and the abutting portion are disposed on a same side of the rotating shaft, when the protruding block is accommodated in the receiving groove, the abutting portion abuts the conductive sheet, and when the protruding block leaves the receiving groove, the abutting portion separates from the conductive sheet.

In some embodiments, the base includes a recess, and the conductive post rotates along with the rotating shaft, to be accommodated in or leave the recess selectively.

In summary, a rotatable terminal module is provided according to an embodiment. When a protruding block on a rotating shaft is to leave a receiving groove (that is, is to move from an open state to a retracted state), the protruding block keeps abutting a main body portion. A counterforce provided by the main body portion can increase a force required when the user intends to retract a terminal assembly. Therefore, the user needs to apply a large force to enable the protruding block to leave the receiving groove. In this way, it can be avoided that when the terminal assembly is in an open state, the protruding block tends to separate from the receiving groove and a conductive post tends to be folded due to an external force or a weight of an apparatus. Further, the protruding block used as a frictional structure and the conductive post used as a conductive structure are separately disposed, so that wear or deformation of the conductive post due to long-time use can be avoided.

### BRIEF DESCRIPTION OF THE DRAWINGS

FIG. 1 is a three-dimensional view of a terminal module according to a first embodiment.

FIG. 2 is an exploded view of the terminal module according to the first embodiment.

FIG. 3 is a cross-sectional view along A-A in FIG. 1.

FIG. 4 is an operation schematic diagram (1) of the terminal module according to the first embodiment.

FIG. 5 is an operation schematic diagram (2) of the terminal module according to the first embodiment.

FIG. 6 is a partial schematic diagram (1) of the terminal module according to the first embodiment.

FIG. 7 is a partial schematic diagram (2) of the terminal module according to the first embodiment.

FIG. 8 is a schematic diagram of a terminal module according to a second embodiment.

FIG. 9 is a schematic diagram of a terminal module according to a third embodiment.

FIG. 10 is a schematic diagram of a terminal module according to a fourth embodiment.

FIG. 11 is a schematic diagram of a terminal module according to a fifth embodiment.

### DETAILED DESCRIPTION

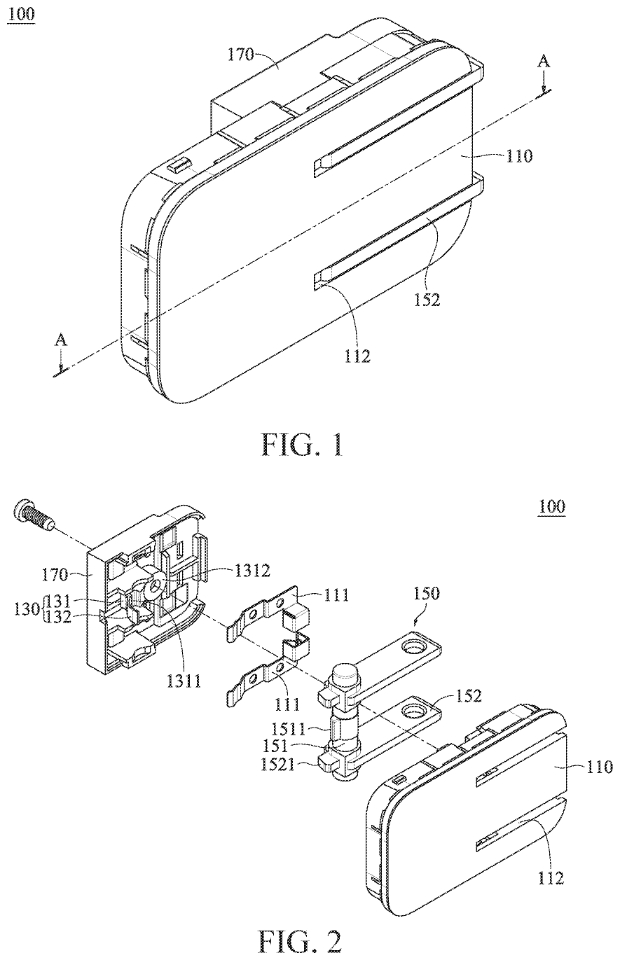

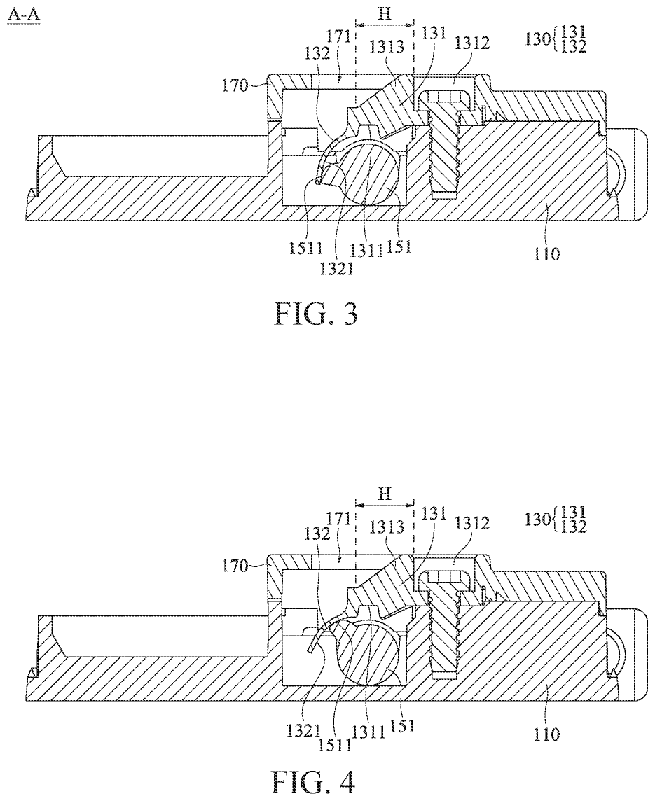

Refer to FIG. 1, FIG. 2, and FIG. 3. FIG. 1 is a three-dimensional view of a terminal module according to a first embodiment. FIG. 2 is an exploded view of the terminal module according to the first embodiment. FIG. 3 is a cross-sectional view along A-A in FIG. 1. A rotatable terminal module, referred to as a terminal module 100 below, includes a base 110, a brake assembly 130, and a terminal assembly 150.

The base 110 includes a conductive sheet 111. In this embodiment, the conductive sheet 111 is an elastic sheet-shaped object that can conduct electricity.

The brake assembly 130 is assembled on the base 110 and includes a main body portion 131 and a wing portion 132. The main body portion 131 has a receiving groove 1311 and a locking portion 1312. An opening of the receiving groove 1311 faces the base 110 and is concavely provided in the main body portion 131. The locking portion 1312 may be a threaded hole, and is locked to the base 110 through a screw or the like in a screwing manner. The wing portion 132 is located on a side of the main body portion 131. The wing portion 132 has a sliding stop portion 1321 on a side facing the base 110. As shown in FIG. 3, the sliding stop portion 1321 extends toward an end away from the receiving groove 1311 in a bent manner.

The terminal assembly 150 is assembled on the base 110 and includes a rotating shaft 151 and a conductive post 152. The rotating shaft 151 has a protruding block 1511. The rotating shaft 151 is pivoted to the base 110, to pivot relative to the base 110, and enable the protruding block 1511 to correspondingly move between the receiving groove 1311 and the sliding stop portion 1321. The rotating shaft 151 is made of an insulating material, and the conductive post 152 is made of a conductive material.

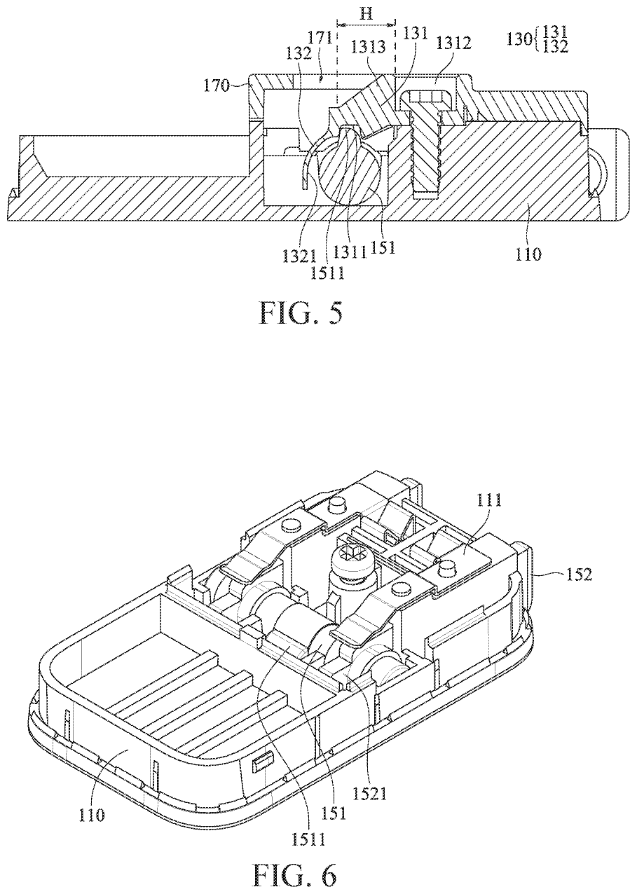

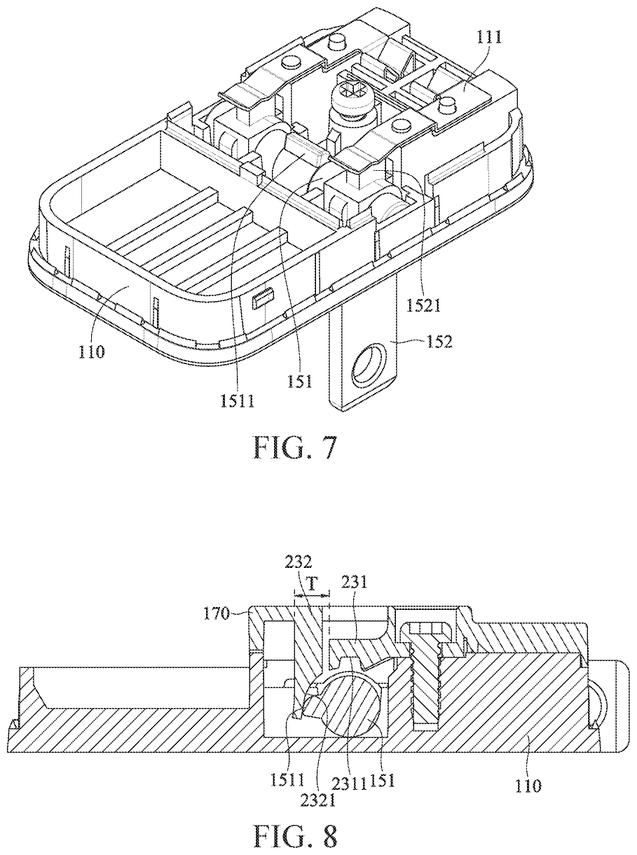

Refer to FIG. 4 and FIG. 7. FIG. 4 is an operation schematic diagram (1) of the terminal module according to the first embodiment. FIG. 5 is an operation schematic diagram (2) of the terminal module according to the first embodiment. FIG. 6 is a partial schematic diagram (1) of the terminal module according to the first embodiment. FIG. 7 is a partial schematic diagram (2) of the terminal module according to the first embodiment. As shown in FIG. 3 to FIG. 5, when a user intends to rotate out the conductive post 152 of the terminal assembly 150 for use in an open state, the conductive post 152 is operated to drive the rotating shaft 151 to rotate, and the protruding block 1511 abuts the sliding stop portion 1321 and slides along the sliding stop portion 1321 to enter the receiving groove 1311. After the user completes use and intends to rotate in the conductive post 152 of the terminal assembly 150 to enter a retracted state, the conductive post 152 is operated to drive the rotating shaft 151 to rotate, and the protruding block 1511 leaves the receiving groove 1311 and enters and stays at the sliding stop portion 1321. In this embodiment, as shown in FIG. 3, when the protruding block 1511 of the rotating shaft 151 leaves the receiving groove 1311 and stays at the sliding stop portion 1321, as shown in FIG. 6, the conductive post 152 is in a retracted state, and in this case an end of the conductive post 152 separates from the conductive sheet 111 to enter a non-conductive state. As shown in FIG. 5, when the protruding block 1511 of the rotating shaft 151 is accommodated in the receiving groove 1311, as shown in FIG. 7, the conductive post 152 is in an open state, and in this case, the end of the conductive post 152 abuts the conductive sheet 111 to enter a conductive state. In this embodiment, the conductive post 152 is used for being inserted into an insertion base to conduct electric energy.

Specifically, when the protruding block 1511 of the terminal module 100 intends to leave the receiving groove 1311, due to a step between the sliding stop portion 1321 and the receiving groove 1311 and a counterforce generated when the protruding block 1511 keeps abutting a groove edge of the receiving groove 1311 on the main body portion 131, the user needs to apply a large force to enable the protruding block 1511 to leave the receiving groove 1311, to retract the conductive post 152. In this case, it can be avoided that the conductive post 152 is folded due to a weight of an apparatus and an external force to rotate to a retracted state during use in an open state. Further, because the protruding block 1511 of the rotating shaft 151 and the conductive post 152 are separately disposed, wear and deformation of the protruding block 1511 caused by friction are kept from affecting the performance of the conductive post 152.

As shown in FIG. 3, in this embodiment, the main body portion 131 and the wing portion 132 are integrally connected. However, this embodiment is not limited thereto. The two may be connected in an assembly manner. In addition, the sliding stop portion 1321 extends from the groove edge of the receiving groove 1311 in a direction away from the receiving groove 1311. In this case, when intending to retract the conductive post 152, the user needs to apply a large force to enable the protruding block 1511 to cross over the groove edge of the receiving groove 1311 to enter the sliding stop portion 1321. In this embodiment, the wing portion 132 is a sheet-shaped object that extends in a direction away from the receiving groove 1311 in a bent manner. When the protruding block 1511 abuts the sliding stop portion 1321, the wing portion 132 deforms elastically, and a counterforce generated when the protruding block 1511 abuts the sliding stop portion 1321 is smaller than that generated from abutting the main body portion 131. Therefore, the user only needs to use a small force to enable the protruding block 1511 move at the sliding stop portion 1321.

As shown in FIG. 3, in this embodiment, the main body portion 131 further includes a restraining block 1313, and the restraining block 1313 is integrally connected above corresponding to the receiving groove 1311. However, this embodiment is not limited thereto. The restraining block 1313 may be connected in an assembly manner. An overall thickness of the main body portion 131 is increased through the restraining block 1313, to increase the counterforce generated when the protruding block 1511 abuts the main body portion 131. In this way, it can be avoided that when the conductive post 152 is in an open state, the protruding block 1511 separates from the receiving groove 1311 due to an external force or the weight of the apparatus to fold the conductive post 152. As shown in FIG. 3, a cross-sectional shape of the restraining block 1313 at least cover a part of the receiving groove 1311. In this embodiment, the cross-sectional shape of the restraining block 1313 may be, for example, a triangle, but is not limited thereto. In addition, when a ratio of a length H of the cross-sectional shape of the restraining block 1313 to a length of the main body portion 131 is higher, a larger counterforce can be provided.

As shown in FIG. 1 and FIG. 3, in this embodiment, the terminal module 100 further includes a top cover 170. The top cover 170 is integrally connected to the brake assembly 130. However, this embodiment is not limited thereto. The two may be connected to each other in an assembly manner. In this embodiment, the top cover 170 covers the brake assembly 130 and is assembled on the base 110. In this case, the top cover 170 protects the brake assembly 130 and the terminal assembly 150 inside, to prevent wear and dirt. In addition, it can be avoided that during operation and use, the user touches the terminal assembly 150 or the conductive sheet 111 by mistake, causing a safety concern. In this embodiment, the top cover further includes a hole 171, which corresponds to a position of the main body portion 131.

As shown in FIG. 1, FIG. 3, and FIG. 5, in this embodiment, the base 110 includes a recess 112. The conductive post 152 is selectively accommodated in or leaves the recess 112. When the conductive post 152 rotates to a retracted state, after the protruding block 1511 leaves the receiving groove 1311, the conductive post 152 is accommodated in the recess 112. When the conductive post 152 rotates to an open state, the protruding block 1511 is accommodated in the receiving groove 1311, and the conductive post 152 leaves the recess 112.

As shown in FIG. 2, in this embodiment, an end of the conductive post 152 close to the rotating shaft 151 further includes an abutting portion 1521, and the protruding block 1511 and the abutting portion 1521 are disposed on a same side of the rotating shaft 151. As shown in FIG. 3 and FIG. 6, when the protruding block 1511 leaves the receiving groove 1311 and abuts the sliding stop portion 1321, the abutting portion 1521 separates from the conductive sheet 111 to enter a non-conductive state. As shown in FIG. 5 and FIG. 7, when the protruding block 1511 is accommodated in the receiving groove 1311, the abutting portion 1521 abuts the conductive sheet 111 to enter a conductive state.

In this solution, there may be various different implementation aspects of the structures of the wing portion and the restraining block, which are further described below with reference to the accompanying drawings. Refer to FIG. 8. FIG. 8 is a schematic diagram of a terminal module according to a second embodiment. The same structures in the second embodiment and the first embodiment are denoted by the same symbols and are not described again. In the second embodiment, a restraining block is not disposed in a main body portion 231. A wing portion 232 is integrally connected to the top cover 170, and protrudes from the top cover 170 toward the base 110. A sliding stop portion 2321 is formed on a side of the wing portion 232 facing a receiving groove 2311 and the base 110, and a gap T exists between the wing portion 232 and the main body portion 231. In the second embodiment, the wing portion 232 is a rib structure. When the protruding block 1511 abuts the sliding stop portion 2321, a large counterforce can be provided. Therefore, the user needs to apply a large force to enable the protruding block 1511 to move at the sliding stop portion 2321. In the second embodiment, when separating from the receiving groove 2311, the protruding block 1511 crosses over the gap T in addition to the groove edge, and an impact generated when the protruding block 1511 crosses over the groove edge and the gap T enhance the operation feel of the user.

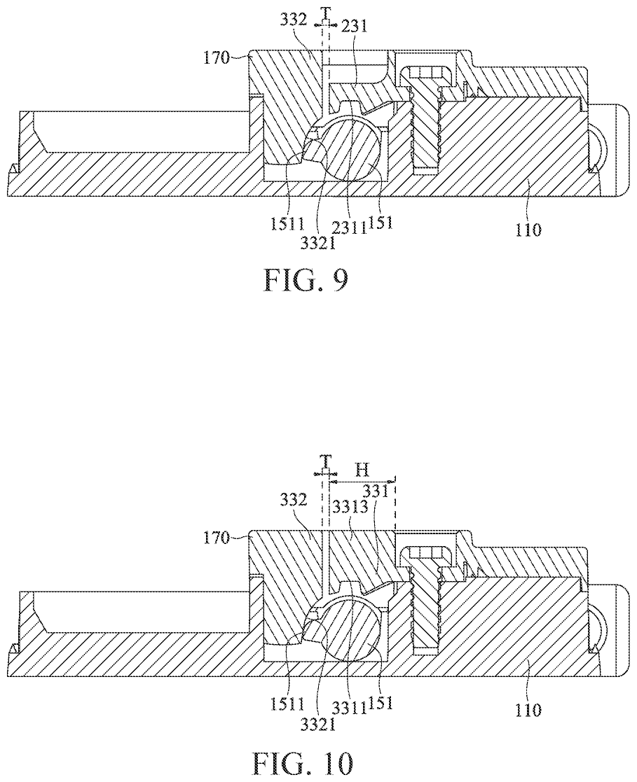

Refer to FIG. 9. FIG. 9 is a schematic diagram of a terminal module according to a third embodiment. The same structures in the third embodiment and the first embodiment are denoted by the same symbols and are not described again. In the third embodiment, a wing portion 332 is a block-shaped structure, is integrally connected to the top cover 170, and protrudes from the top cover 170 toward the base 110. As shown in FIG. 9, a sliding stop portion 3321 is formed on a side of the wing portion 332 facing the receiving groove 2311 and the base 110. An opposite side of the side of the wing portion 332 facing the receiving groove 2311 is tightly close to the top cover 170 and the base 110. When the protruding block 1511 abuts the sliding stop portion 3321, a larger counterforce is generated, and the user needs to apply a larger force to move the protruding block 1511. In this way, it can also be avoided that when the conductive post 152 is in a retracted state, a force between the protruding block 1511 and the sliding stop portion 3321 is excessively small, and the protruding block 1511 tends to move onto the sliding stop portion 3321 under an external force and as a result the conductive post 152 leaves the recess 112.

Refer to FIG. 10. FIG. 10 is a schematic diagram of a terminal module according to a fourth embodiment. The same structures in the fourth embodiment and the third embodiment are denoted by the same symbols and are not described again. In the fourth embodiment, a main body portion 331 includes a receiving groove 3311 and a restraining block 3313. The restraining block 3313 extends from above corresponding to the receiving groove 3311 and is integrally connected to the top cover 170. As shown in FIG. 10, a cross-sectional shape of the restraining block 3313 is a rectangle. Compared with the triangle in FIG. 3, the rectangle covers an area of the receiving groove 3311 with a larger length H and a larger thickness, to provide a larger counterforce. In this way, it can also be avoided that when the conductive post 152 is in an open state, the protruding block 1511 separates from the receiving groove 3311 due to an external force or the weight of the apparatus to fold the conductive post 152.

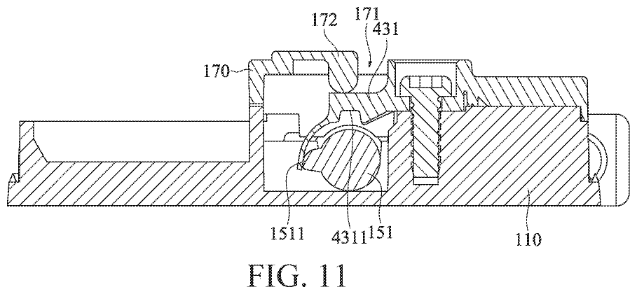

Refer to FIG. 11. FIG. 11 is a schematic diagram of a terminal module according to a fifth embodiment. The same structures in the fifth embodiment and the first embodiment are denoted by the same symbols and are not described again. In the fifth embodiment, a restraining block is not disposed in a main body portion 431. As shown in FIG. 11, the top cover 170 includes a restraining arm 172, and the restraining arm 172 is integrally connected to the top cover 170 and extends toward the main body portion 431, and abuts above corresponding to the main body portion 431. When the protruding block 1511 is to leave a receiving groove 4311 and abuts a side edge of the main body portion 431, as the main body portion 431 is pushed to elastically deform in a direction of the hole 171, a larger counterforce can be provided through the restraining arm 172, and as a result the user needs to apply a larger force to enable the protruding block 1511 to separate from the receiving groove 4311. In this way, it can also be avoided that when the conductive post 152 is in an open state, the protruding block 1511 separates from the receiving groove 4311 due to an external force or the weight of the apparatus to fold the conductive post 152.

What is claimed is:

1. A rotatable terminal module, comprising:
a base, comprising a conductive sheet;
a brake assembly, assembled on the base, the brake assembly comprising:
a main body portion, having a receiving groove and a locking portion, the locking portion being locked to the base; and
a wing portion, located on a side of the main body portion, the wing portion having a sliding stop portion on a side facing the base, the sliding stop portion extending toward an end away from the receiving groove; and
a terminal assembly, assembled on the base, the terminal assembly comprising:
a rotating shaft, having a protruding block, wherein the rotating shaft is pivoted to the base, the protruding block corresponds to the receiving groove and the sliding stop portion, and as the rotating shaft rotates, the protruding block enters the receiving groove along the sliding stop portion or leaves the receiving groove and stays at the sliding stop portion; and
a conductive post, connected to the rotating shaft, and driving the rotating shaft to rotate,
wherein when the protruding block is accommodated in the receiving groove, the conductive post abuts the conductive sheet, and when the protruding block leaves the receiving groove, the conductive post separates from the conductive sheet.

2. The rotatable terminal module according to claim 1, wherein the wing portion is connected to the main body portion, and the sliding stop portion extends from a groove edge of the receiving groove in a direction away from the receiving groove.

3. The rotatable terminal module according to claim 1, further comprising a top cover, assembled on the base, wherein the brake assembly is connected to the top cover.

4. The rotatable terminal module according to claim 3, wherein the wing portion is connected to the top cover, the sliding stop portion is formed on a side of the wing portion facing the receiving groove, and a gap exists between the wing portion and the main body portion.

5. The rotatable terminal module according to claim 3, wherein the main body portion further comprises a restraining block, and the restraining block extends from above corresponding to the receiving groove and is connected to the top cover.

6. The rotatable terminal module according to claim 3, wherein the top cover comprises a restraining arm, and the restraining arm is connected to the top cover and extends toward the main body portion, and abuts above corresponding to the main body portion.

7. The rotatable terminal module according to claim 6, wherein the restraining arm abuts above corresponding to the receiving groove of the main body portion.

8. The rotatable terminal module according to claim 1, wherein the main body portion further comprises a restraining block, and the restraining block is connected above corresponding to the receiving groove.

9. The rotatable terminal module according to claim 1, wherein an end of the conductive post close to the rotating shaft further comprises an abutting portion, the protruding block and the abutting portion are disposed on a same side of the rotating shaft, when the protruding block is accommodated in the receiving groove, the abutting portion abuts the conductive sheet, and when the protruding block leaves the receiving groove, the abutting portion separates from the conductive sheet.

10. The rotatable terminal module according to claim 1, wherein the base comprises a recess, and the conductive post is accommodated in or leaves the recess selectively.
